(19) United States
(12) Patent Application Publication
(10) Pub. No.: US 2026/0201820 A1
(43) Pub. Date: Jul. 16, 2026

(54) DUCT AND GAS TURBINE

(71) Applicant: MITSUBISHI HEAVY INDUSTRIES, LTD., Tokyo (JP)

(72) Inventors: Tomohiro GOTO, Tokyo (JP); Shinji OSADA, Kanagawa (JP)

(21) Appl. No.: 19/439,747

(22) Filed: Jan. 5, 2026

(30) Foreign Application Priority Data
Jan. 14, 2025 (JP) 2025-004505

(51) Int. Cl. F01D 25/30; F02C 3/00

(52) U.S. Cl. CPC F01D 25/30; F02C 3/00

(57) ABSTRACT

A duct, having a rectangular cross-section perpendicular to a flow direction of a fluid, includes: a C-shaped first block forming a part of the rectangular shape; and a C-shaped second block forming a part of the rectangular shape and disposed opposite the first block across a plane including a central axis of the duct. The first block includes, when viewed along the central axis, a first wall portion extending in a first direction perpendicular to an extending direction of the central axis. The second block includes, when viewed along the central axis, a fourth wall portion extending in the first direction. A distance between the first and fourth wall portions gradually increases from one side toward the other side in the flow direction. A plurality of the first blocks are arranged side-by-side in the flow direction, and a plurality of the second blocks are arranged side-by-side in the flow direction.

### TECHNICAL FIELD

The present disclosure relates to a duct and a gas turbine.

The present application claims priority based on Japanese Patent Application No. 2025-004505 filed on Jan. 14, 2025, the entire content of which is incorporated herein by reference.

### BACKGROUND ART

A gas turbine includes a compressor for generating compressed air, a combustor for generating combustion gas by burning a mixture of the compressed air generated by the compressor and fuel, and a turbine driven to rotate by the combustion gas generated by the combustor.

An exhaust duct is connected to the turbine and is configured to conduct hot exhaust gas after driving the turbine to a heat recovery steam generator or the like through the exhaust duct. Further, an intake duct is connected to the compressor and is configured to supply air to the compressor through the intake duct (see, for example, Patent Document 1).

### CITATION LIST

### Patent Literature

Patent Document 1: JP2022-48137A

### SUMMARY

For example, since industrial gas turbines are relatively large, intake ducts and exhaust ducts are also relatively large.

Therefore, for transportation convenience and other reasons, the ducts may be assembled and installed by joining duct components of transportable size at the installation site of the gas turbine. In particular, when a duct is large in the flow direction of the fluid flowing inside the duct, the duct may be divided in the flow direction, and the divided duct components may be assembled and installed.

For example, when dividing a portion of the duct where the cross-sectional area of the passage reduces or expands in the flow direction, the types of duct components with different shapes increase, which increases the burden of design, strength analysis during lifting, and the like. In addition, duct components with different shapes create matters that cannot be standardized even in the manufacturing process. Therefore, it is desirable to reduce design effort and manufacturing cost by minimizing the types of duct components with different shapes.

In view of the above circumstances, an object of at least one embodiment of the present disclosure is to provide a duct and a gas turbine whereby it is possible to reduce design effort and manufacturing cost.

(1) A duct according to at least one embodiment of the present disclosure is a duct that forms a passage through which a fluid flows, a cross-section of the passage perpendicular to a flow direction of the fluid having a rectangular shape. The duct includes: a C-shaped first block forming a part of the rectangular shape; and a C-shaped second block forming a part of the rectangular shape and disposed opposite the first block across a plane including a central axis of the duct. The first block, when viewed along the central axis, includes: a first wall portion extending in a first direction perpendicular to an extending direction of the central axis; a second wall portion extending from an end portion of the first wall portion on one side in the first direction to one side in a second direction that is perpendicular to the extending direction of the central axis and intersects the first direction; and a third wall portion extending from an end portion of the first wall portion on the other side in the first direction to the one side in the second direction. The second block, when viewed along the central axis, includes: a fourth wall portion extending in the first direction; a fifth wall portion extending from an end portion of the fourth wall portion on the one side in the first direction to the other side in the second direction; and a sixth wall portion extending from an end portion of the fourth wall portion on the other side in the first direction to the other side in the second direction. The duct further includes: a seventh wall portion connecting an end portion of the second wall portion on the one side in the second direction and an end portion of the fifth wall portion on the other side in the second direction; and an eighth wall portion connecting an end portion of the third wall portion on the one side in the second direction and an end portion of the sixth wall portion on the other side in the second direction. A distance between the first wall portion and the fourth wall portion gradually increases from one side toward the other side in the flow direction. A plurality of the first blocks are arranged side-by-side in the flow direction, and a plurality of the second blocks are arranged side-by-side in the flow direction.

(2) A gas turbine according to at least one embodiment of the present disclosure includes: a compressor for generating compressed air; a combustor for generating combustion gas by burning a mixture of the compressed air generated by the compressor and fuel; a turbine driven to rotate by the combustion gas generated by the combustor; an intake duct of the compressor; and an exhaust duct of the turbine. At least one of the intake duct or the exhaust duct has a cross-sectional shape of the passage changed by the duct having the above configuration (1).

According to at least one embodiment of the present disclosure, it is possible to reduce design effort and manufacturing cost by reducing the types of duct components with different shapes.

### BRIEF DESCRIPTION OF DRAWINGS

FIG. 1 is a diagram showing a configuration example of a gas turbine according to an embodiment.

FIG. 2 is a schematic perspective view of a duct in the gas turbine according to an embodiment.

FIG. 3 is a schematic perspective view for describing the arrangement of duct components in the duct according to an embodiment.

FIG. 4 is a schematic plan view for describing the arrangement of duct components in the duct according to an embodiment.

FIG. 5 is a cross-sectional view taken along line V-V of FIG. 4.

FIG. 6 is a schematic perspective view showing an example of a state during a lifting operation of duct components.

FIG. 7 is a schematic plan view for describing the duct assembly procedure.

FIG. 8 is a schematic plan view for describing the duct assembly procedure.

FIG. 9 is a schematic plan view for describing the duct assembly procedure.

FIG. 10 is a schematic plan view for describing the duct assembly procedure.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

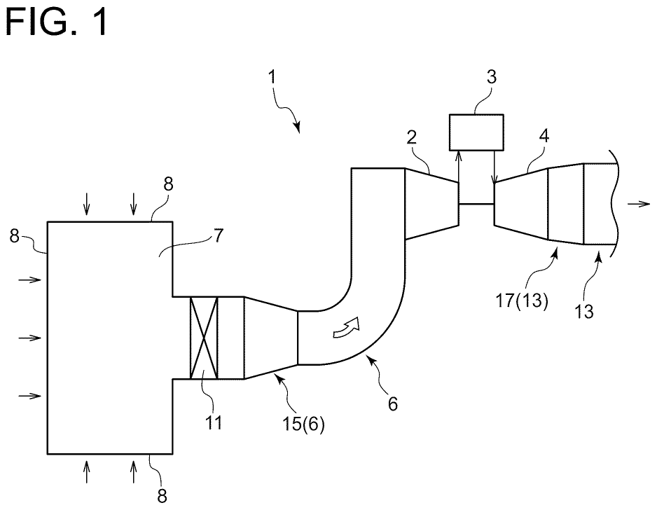

FIG. 1 is a diagram showing a configuration example of a gas turbine according to an embodiment. As shown in the figure, a gas turbine 1 includes a compressor 2, a combustor 3, and a turbine 4.

The compressor 2 is configured to compress intake air to generate compressed air. The combustor 3 is configured to generate combustion gas by burning a mixture of the air compressed by the compressor 2 and fuel. The turbine 4 is configured to be driven to rotate by the combustion gas generated by the combustor 3 to generate power. The turbine 4 is connected to a generator (not shown), so that power generated by the turbine 4 is converted into electric power by the generator.

The intake side of the compressor 2 communicates with an intake chamber 7 through an intake duct 6. At least some of the wall surfaces of the intake chamber 7 defining the intake chamber 7 are an intake surface 8 for taking in air. The air taken into the intake chamber 7 from outside through the intake surface 8 flows through the intake duct 6 as indicated by the white arrow and is supplied to the intake side of the compressor 2.

As shown in FIG. 1, the wall surface (intake surface 8) of the intake chamber 7 may be equipped with a filter (not shown) for removing dust contained in the air taken into the intake surface 8. Further, a weather louver (not shown) may be provided on the outer wall surface of the intake chamber 7 to prevent intrusion of rainwater and other elements into the intake chamber 7.

The intake duct 6 may be equipped with a silencer 11 to reduce intake noise.

An exhaust duct 13 is connected to the turbine 4. The gas turbine 1 according to an embodiment is configured to conduct the hot exhaust gas after driving the turbine 4 to a heat recovery steam generator (not shown) or the like through the exhaust duct 13.

In the gas turbine 1 according to an embodiment, a contraction duct 15 configured such that the cross-sectional area of the passage decreases from upstream to downstream in the flow direction of air may be provided in the middle of the intake duct 6.

Further, in the gas turbine 1 according to an embodiment, an expansion duct 17 configured such that the cross-sectional area of the passage increases from upstream to downstream in the flow direction of exhaust gas may be provided in the middle of the exhaust duct 13.

In the gas turbine 1 according to an embodiment, for transportation convenience and other reasons, the intake duct 6 and the exhaust duct 13 are assembled and installed by joining duct components of transportable size at the installation site of the gas turbine 1. Therefore, the intake duct 6 and the exhaust duct 13 are composed of multiple duct components.

For example, in regions of the intake duct 6 and the exhaust duct 13 where there is no change in the cross-sectional area of the passage in the flow direction of the fluid (air, exhaust gas) flowing inside, the duct can be assembled by connecting duct components of the same shape in the flow direction of the fluid, so the types of duct components with different shapes are relatively few.

However, in regions of the intake duct 6 and the exhaust duct 13 where the cross-sectional area of the passage changes from upstream to downstream in the flow direction of the fluid, the cross-sectional area of the passage differs depending on the position in the flow direction of the fluid. Therefore, if this region is divided into a plurality of duct components in the flow direction of the fluid, the types of duct components with different shapes will increase. In this case, as the types of duct components with different shapes increase, the burden of design, strength analysis during lifting, and the like increases. In addition, duct components with different shapes create matters that cannot be standardized even in the manufacturing process. Therefore, it is desirable to reduce design effort and manufacturing cost by minimizing the types of duct components with different shapes.

Therefore, in the gas turbine 1 according to an embodiment, design effort and manufacturing cost are reduced as follows in a duct where the cross-sectional area of the passage changes from upstream to downstream in the flow direction of the fluid. Hereinafter, the duct according to an embodiment, in which the cross-sectional area of the passage changes from upstream to downstream in the flow direction of the fluid, will be described.

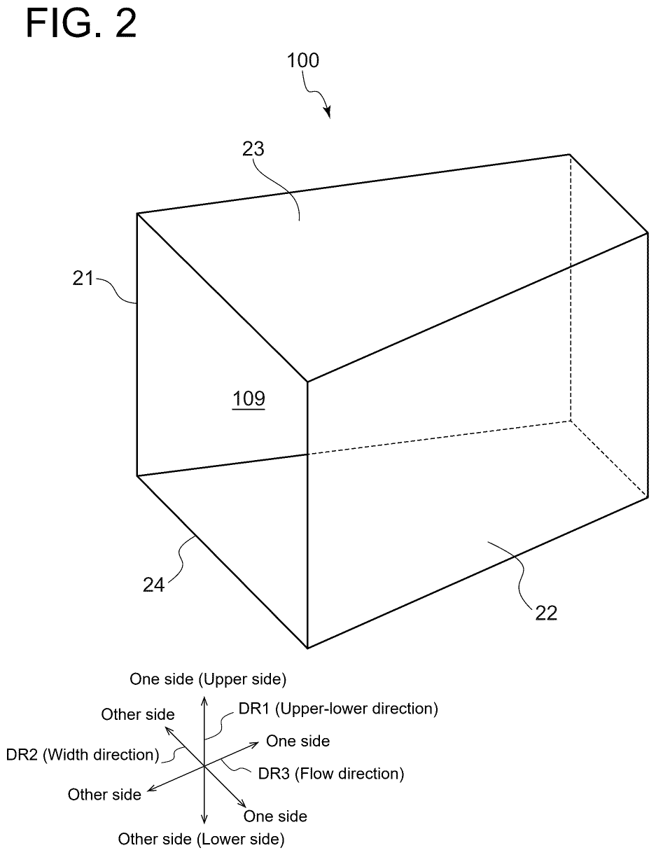

FIG. 2 is a schematic perspective view of a duct 100 in the gas turbine 1 according to an embodiment.

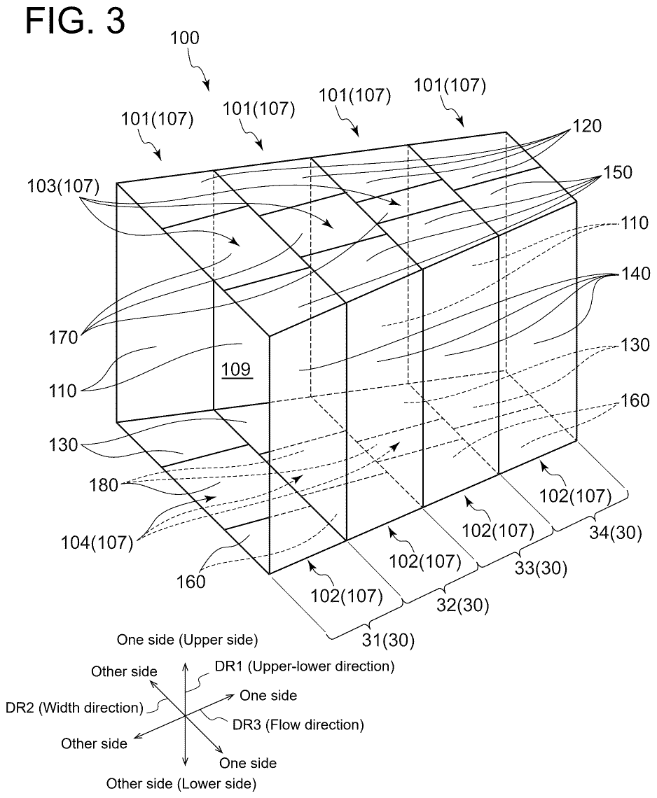

FIG. 3 is a schematic perspective view for describing the arrangement of duct components 107 in the duct 100 according to an embodiment.

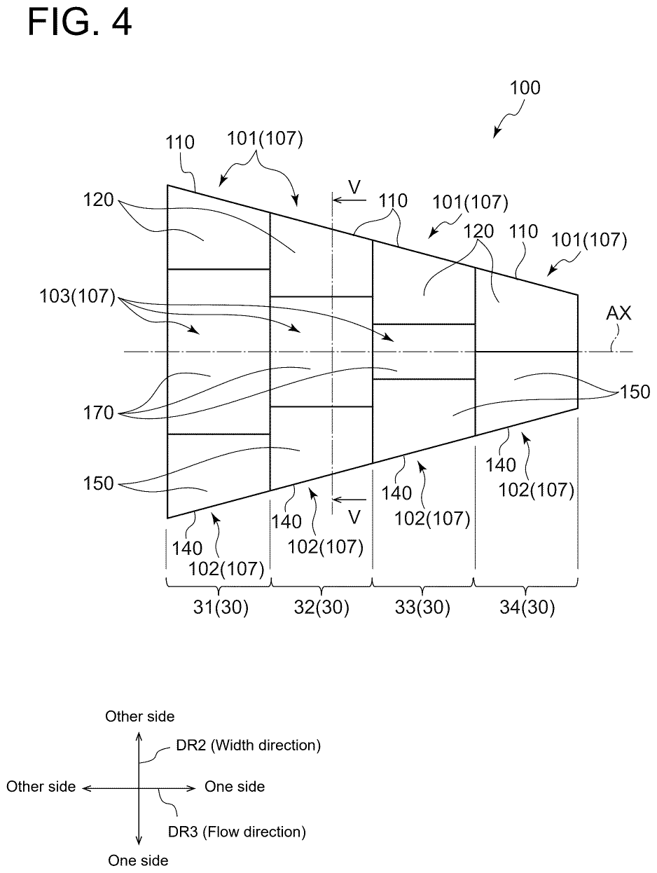

FIG. 4 is a schematic plan view for describing the arrangement of duct components 107 in the duct 100 according to an embodiment.

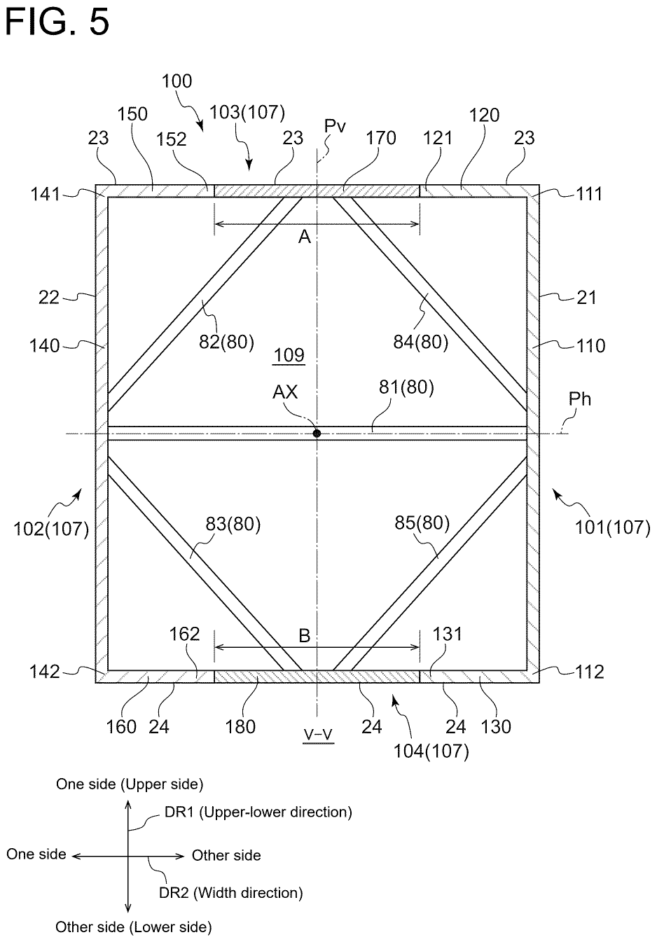

FIG. 5 is a cross-sectional view taken along line V-V of FIG. 4.

In FIG. 2 and FIG. 3, illustration of a reinforcing member 80, which will be described later, is omitted.

### Duct 100

The duct 100 in the gas turbine 1 according to an embodiment is, for example, a contraction duct used as the contraction duct 15 provided in the middle of the intake duct 6 described above, but may be, for example, an expansion duct used as the expansion duct 17 configured such that the cross-sectional area of the passage increases from upstream to downstream in the flow direction of exhaust gas in the middle of the exhaust duct 13 described above. The following description is primarily for the case where the duct 100 is a contraction duct, but the following description also applies to the case where the duct 100 is an expansion duct, to the extent that no contradictions arise.

The duct 100 according to an embodiment is a duct that forms a passage 109 through which a fluid flows, and the cross-section of the passage 109 perpendicular to the flow direction of the fluid has a rectangular shape.

In the following description, the flow direction of the fluid in the passage 109 is also referred to simply as the flow direction.

For convenience of description, the upper-lower direction of the duct 100 is defined as a first direction DR1, the upper side in the upper-lower direction is defined as one side in the first direction DR1, and the lower side in the upper-lower direction is defined as the other side in the first direction DR1. In the following description, the upper-lower direction, i.e., the first direction DR1, is a vertical direction, but it may not be the vertical direction.

For convenience of description, the width direction of the duct 100 is defined as a second direction DR2. Of the second direction DR2, the direction toward the front side of the page in FIG. 2 and FIG. 3 is defined as one side in the second direction DR2, and the direction toward the back side of the page in FIG. 2 and FIG. 3 is defined as the other side in the second direction DR2. When the first direction DR1 is the vertical direction, the second direction DR2 is the horizontal direction, but the second direction DR2 does not necessarily have to be perpendicular to the first direction DR1.

For convenience of description, the flow direction of the fluid in the passage 109 of the duct 100 is defined as a third direction DR3. Of the third direction DR3, the direction toward the right side of the page in FIG. 2 and FIG. 3 is defined as one side in the third direction DR3, and the direction toward the left side of the page in FIG. 2 and FIG. 3 is defined as the other side in the third direction DR3. When the duct 100 is the contraction duct 15 of the intake duct 6, one side in the third direction DR3 is the downstream side in the flow direction, and the other side in the third direction DR3 is the upstream side in the flow direction. When the duct 100 is the expansion duct 17 of the exhaust duct 13, one side in the third direction DR3 is the upstream side in the flow direction, and the other side in the third direction DR3 is the downstream side in the flow direction.

In the duct 100 according to an embodiment, the central axis AX of the duct 100 extends in the third direction DR3.

The duct 100 according to an embodiment, when viewed from the extending direction of the central axis AX, is surrounded by: a side wall portion 21 located on one side in the second direction DR2 with respect to the central axis AX; a side wall portion 22 located on the other side in the second direction DR2 with respect to the central axis AX; an upper wall portion 23 located on one side in the first direction DR1 with respect to the central axis AX; and a lower wall portion 24 located on the other side in the first direction DR1 with respect to the central axis AX.

In the duct 100 according to an embodiment, a distance in the second direction DR2 between the side wall portion 21 and the side wall portion 22, which face each other in the second direction DR2 across the central axis AX, gradually increases from one side to the other side in the third direction DR3.

In the duct 100 according to an embodiment, a distance in the first direction DR1 between the upper wall portion 23 and the lower wall portion 24, which face each other in the first direction DR1 across the central axis AX, is constant regardless of the position in the third direction DR3.

This results in a duct 100 with a flow path area that gradually increases from one side to the other side in the third direction DR3.

The side wall portion 21 is a first wall portion group formed by respective first wall portions 110 of a plurality of the first blocks 101 arranged side-by-side in the third direction DR3, as will be described later. Further, the side wall portion 22 is a fourth wall portion group formed by respective fourth wall portions 140 of a plurality of the second blocks 102 arranged side-by-side in the third direction DR3, as will be described later.

The duct 100 according to an embodiment includes a plurality of duct components 107, and by connecting the plurality of duct components, is assembled and installed as a duct in which the passage 109 having a rectangular cross-sectional shape is formed.

In the duct 100 according to an embodiment, duct components 107 adjacent in the second direction DR2 are connected to each other, and duct components 107 adjacent in the third direction DR3 are connected to each other. The adjacent duct components 107 are connected, for example, by joining flange portions (not shown) protruding from the inside toward the outside of the duct 100 with bolt members.

The duct 100 according to an embodiment includes, as the plurality of duct components 107: a first block 101; a second block 102; a third block 103; and a fourth block 104.

### First Block 101

In the duct 100 according to an embodiment, the first block 101 is a C-shaped duct component 107 that forms a part of the above-described rectangular cross-sectional shape of the passage 109.

The first block 101, when viewed along the central axis AX, includes: a first wall portion 110 extending in the first direction DR1; a second wall portion 120 extending from an end portion 111 of the first wall portion 110 on one side in the first direction DR1 to one side in the second direction DR2; and a third wall portion 130 extending from an end portion 112 of the first wall portion 110 on the other side in the first direction DR1 to one side in the second direction DR2.

In the first block 101, when assembled as the duct 100, a distance in the second direction DR2 from the central axis AX to the first wall portion 110 gradually increases from one side to the other side in the third direction DR3. In other words, in the duct 100 according to an embodiment, the first wall portion 110 is inclined with respect to a plane Pv (see FIG. 5) including the central axis AX and extending in the first direction DR1.

In the first block 101, when assembled as the duct 100, a distance in the first direction DR1 from the central axis AX to the second wall portion 120 and a distance in the first direction DR1 from the central axis AX to the third wall portion 130 are constant regardless of the position in the third direction DR3.

The first block 101 has the same shape and size as a shape and size obtained when, for one of segments of the duct 100 (assumed to be integrally formed) divided in the third direction DR3, only a region on the other side in the second direction DR2 remains.

Each of the plurality of first blocks 101 arranged side-by-side in the third direction DR3 has the same external dimension. This reduces the design effort, even if the duct 100 includes a plurality of the first blocks 101, because design, strength analysis during lifting, and the like need only for one first block 101. In addition, since the first blocks 101 can be manufactured in the same manufacturing process using the same components, manufacturing cost can be reduced, and since the skill level of workers involved in manufacturing tends to increase, quality improvement can also be expected.

The fact that the plurality of first blocks 101 has the same external dimension means that the shape and size of the plate portions of the first wall portion 110, the second wall portion 120, and the third wall portion 130, excluding appendages or openings, i.e., the portions corresponding to the inner surface and the outer surface of the duct 100, are the same among the plurality of first blocks 101.

### Second Block 102

In the duct 100 according to an embodiment, the second block 102 is a C-shaped duct component 107 that forms a part of the above-described rectangular cross-sectional shape of the passage 109 and is disposed opposite the first block 101 across the plane Pv (see FIG. 5) including the central axis AX and extending in the first direction DR1. When the first direction DR1 is the vertical direction, the plane Pv is a vertical plane.

The second block 102, when viewed along the central axis AX, includes: a fourth wall portion 140 extending in the first direction DR1; a fifth wall portion 150 extending from an end portion 141 of the fourth wall portion 140 on one side in the first direction DR1 to the other side in the second direction DR2; and a sixth wall portion 160 extending from an end portion 142 of the fourth wall portion 140 on the other side in the first direction DR1 to the other side in the second direction DR2.

In the second block 102, when assembled as the duct 100, a distance in the second direction DR2 from the central axis AX to the fourth wall portion 140 gradually increases from one side to the other side in the third direction DR3. In other words, in the duct 100 according to an embodiment, the fourth wall portion 140 is inclined with respect to the plane Pv (see FIG. 5) including the central axis AX and extending in the first direction DR1.

In the second block 102, when assembled as the duct 100, a distance in the first direction DR1 from the central axis AX to the fifth wall portion 150 and a distance in the first direction DR1 from the central axis AX to the sixth wall portion 160 are constant regardless of the position in the third direction DR3.

The second block 102 has the same shape and size as a shape and size obtained when, for one of segments of the duct 100 (assumed to be integrally formed) divided in the third direction DR3, only a region on one side in the second direction DR2 remains.

Each of the plurality of second blocks 102 arranged side-by-side in the third direction DR3 has the same external dimension. This reduces the design effort, even if the duct 100 includes a plurality of the second blocks 102, because design, strength analysis during lifting, and the like need only for one second block 102. In addition, since the second blocks 102 can be manufactured in the same manufacturing process using the same components, manufacturing cost can be reduced, and since the skill level of workers involved in manufacturing tends to increase, quality improvement can also be expected.

The fact that the plurality of second blocks 102 has the same external dimension means that the shape and size of the plate portions of the fourth wall portion 140, the fifth wall portion 150, and the sixth wall portion 160, excluding appendages or openings, i.e., the portions corresponding to the inner surface and the outer surface of the duct 100, are the same among the plurality of second blocks 102.

### Shapes of First Block 101 and Second Block 102

In the duct 100 according to an embodiment, the dimension of the second block 102 in the third direction DR3 is the same as the dimension of the first block 101 in the third direction DR3. Thus, even if a plurality of the first blocks 101 and a plurality of the second blocks 102 are respectively arranged side-by-side in the third direction DR3, the length of the duct 100 in a region where the plurality of first blocks 101 are arranged side-by-side and the length of the duct 100 in a region where the plurality of second blocks 102 are arranged side-by-side can be matched.

In the duct 100 according to an embodiment, the external shape of the first block 101 and the external shape of the second block 102 are symmetrical with respect to the plane Pv including the central axis AX. Thus, if one of the first block 101 and the second block 102 is designed, the other can be designed based on the result of that design, and if strength analysis during lifting or the like is performed for one, the result can be used for the strength analysis during lifting or the like for the other. This reduces the design burden.

### Third Block 103

In the duct 100 according to an embodiment, the third block 103 is an I-shaped duct component 107 that forms a part of the above-described rectangular cross-sectional shape of the passage 109.

The third block 103, when viewed along the central axis AX, includes a seventh wall portion 170 extending in the second direction DR2. The seventh wall portion 170 connects an end portion 121 of the second wall portion 120 on one side in the second direction DR2 and an end portion 152 of the fifth wall portion 150 on the other side in the second direction DR2.

The third block 103 has the same shape and size as a shape and size obtained when a region in the vicinity of the center in the second direction DR2, within a region of the upper wall portion 23 of the duct 100 excluding one side in the third direction DR3, is divided into several segments in the third direction DR3.

Each of the plurality of third blocks 103 arranged side-by-side in the third direction DR3 has the same length in the third direction DR3.

### Fourth Block 104

In the duct 100 according to an embodiment, the fourth block 104 is an I-shaped duct component 107 that forms a part of the above-described rectangular cross-sectional shape of the passage 109 and is disposed opposite the third block 103 across a plane Ph (see FIG. 5) including the central axis AX and extending in the second direction DR2. When the second direction DR2 is the horizontal direction, the plane Ph is a horizontal plane.

The fourth block 104, when viewed along the central axis AX, includes an eighth wall portion 180 extending in the second direction DR2. The eighth wall portion 180 connects an end portion 131 of the third wall portion 130 on one side in the second direction DR2 and an end portion 162 of the sixth wall portion 160 on the other side in the second direction DR2.

The fourth block 104 has the same shape and size as a shape and size obtained when a region in the vicinity of the center in the second direction DR2, within a region of the lower wall portion 24 of the duct 100 excluding one side in the third direction DR3, is divided into several segments in the third direction DR3.

Each of the plurality of fourth blocks 104 arranged side-by-side in the third direction DR3 has the same length in the third direction DR3.

### Shapes of Third Block 103 and Fourth Block 104

In the duct 100 according to an embodiment, the dimension of the third block 103 in the third direction DR3 is the same as the dimension of the fourth block 104 in the third direction DR3.

In the duct 100 according to an embodiment, the dimension of the third block 103 in the third direction DR3 is the same as the dimensions of the first block 101 and the second block 102 in the third direction DR3. Therefore, the dimension of the fourth block 104 in the third direction DR3 is also the same as the dimensions of the first block 101 and the second block 102 in the third direction DR3.

Thus, even if a plurality of the first blocks 101, a plurality of the second blocks 102, and a plurality of the third blocks 103 are respectively arranged side-by-side in the third direction DR3, the length of the duct 100 in a region where the plurality of first blocks 101 are arranged side-by-side, the length of the duct in a region where the plurality of second blocks 102 are arranged side-by-side, and the length of the duct 100 in a region where the plurality of third blocks 103 are arranged side-by-side can be matched.

Similarly, even if a plurality of the first blocks 101, a plurality of the second blocks 102, and a plurality of the fourth blocks 104 are respectively arranged side-by-side in the third direction DR3, the length of the duct 100 in a region where the plurality of first blocks 101 are arranged side-by-side, the length of the duct in a region where the plurality of second blocks 102 are arranged side-by-side, and the length of the duct 100 in a region where the plurality of fourth blocks 104 are arranged side-by-side can be matched.

### Positional Relationship of First Block 101 to Fourth Block 104

The duct 100 according to an embodiment has a plurality of pairs of the first block 101 and the second block 102 arranged at overlapping positions in the third direction DR3. In the duct 100 according to an embodiment, for pairs other than the pair of the first block 101 and the second block 102 arranged outermost on one side in the third direction DR3, the third block 103 and the fourth block 104 are arranged between the first block 101 and the second block 102.

In the duct 100 according to an embodiment, each of the pairs other than the pair of the first block 101 and the second block 102 arranged outermost on one side in the third direction DR3 forms a section 30 (see FIG. 3 and FIG. 4) of the duct 100, i.e., a section 30 in the third direction DR3, by the pair of the first block 101 and the second block 102, and the third block 103 and the fourth block 104 arranged between the first block 101 and the second block 102. In the duct 100 according to an embodiment, the pair of the first block 101 and the second block 102 arranged outermost on one side in the third direction DR3 forms a section 30 of the duct 100.

In the duct 100 according to an embodiment, in the pair of the first block 101 and the second block 102 arranged at overlapping positions in the third direction DR3, a distance in the second direction DR2 between the first wall portion 110 and the fourth wall portion 140 gradually increases from one side to the other side in the third direction DR3.

In the duct 100 according to an embodiment, the second wall portion 120 of the first block 101 and the seventh wall portion 170 of the third block 103, which are adjacent in the second direction DR2, are continuous without a step in the first direction DR1, and the fifth wall portion 150 of the second block 102 and the seventh wall portion 170 of the third block 103, which are adjacent in the second direction DR2, are continuous without a step in the first direction DR1.

In the duct 100 according to an embodiment, the third wall portion 130 of the first block 101 and the eighth wall portion 180 of the fourth block 104, which are adjacent in the second direction DR2, are continuous without a step in the first direction DR1, and the sixth wall portion 160 of the second block 102 and the eighth wall portion 180 of the fourth block 104, which are adjacent in the second direction DR2, are continuous without a step in the first direction DR1.

### Arrangement of First Block 101 to Fourth Block 104 in Third Direction DR3

In the duct 100 according to an embodiment, a plurality of the first blocks 101 are arranged side-by-side in the third direction DR3, and a plurality of the second blocks 102 are arranged side-by-side in the third direction DR3.

Therefore, with the duct 100 according to the embodiment, by arranging a plurality of the first blocks 101 side-by-side in the third direction DR3 and arranging a plurality of the second blocks 102 side-by-side in the third direction DR3, a relatively large duct 100 can be installed while keeping the first blocks 101 and the second blocks 102 to a transportable size. Further, with the duct 100 according to the embodiment, since the duct 100 includes the plurality of first blocks 101 and second blocks 102, even for a relatively large duct 100, the types of duct components 107 with different shapes can be reduced, and design effort and manufacturing cost can be reduced.

Therefore, the gas turbine 1 with the duct 100 according to the embodiment also achieves the same advantageous effects as those described above. That is, with the gas turbine 1 according to the embodiment, a relatively large duct 100 can be installed while keeping the size of the duct components 107 to a transportable size. Further, with the gas turbine 1 according to the embodiment, even for a relatively large duct 100, the types of duct components 107 with different shapes can be reduced, and design effort and manufacturing cost can be reduced.

In the duct 100 according to an embodiment, a plurality of the third blocks 103 are arranged side-by-side in the third direction DR3, and a plurality of the fourth blocks 104 are arranged side-by-side in the third direction DR3. That is, a plurality of the seventh wall portions 170 are arranged side-by-side in the third direction DR3, and a plurality of the eighth wall portions 180 are arranged side-by-side in the third direction DR3.

Therefore, with the duct 100 according to the embodiment, by arranging a plurality of the seventh wall portions 170 side-by-side in the third direction DR3 and arranging a plurality of the eighth wall portions 180 side-by-side in the third direction DR3, a relatively large duct 100 can be installed while keeping the seventh wall portions 170 and the eighth wall portions 180 to a transportable size. Further, with the duct 100 according to the embodiment, since the duct 100 includes the plurality of seventh wall portions 170 and eighth wall portions 180, even for a relatively large duct 100, the types of duct components 107 with different shapes can be reduced, and design effort and manufacturing cost can be reduced.

In the duct 100 according to an embodiment, respective first wall portions 110 of the first blocks 101 adjacent in the third direction DR3 are continuous without a step in the second direction DR2, and respective fourth wall portions 140 of the second blocks 102 adjacent in the third direction DR3 are continuous without a step in the second direction DR2.

In the duct 100 according to an embodiment, respective second wall portions 120 of the first blocks 101 adjacent in the third direction DR3 are continuous without a step in the first direction DR1, and respective third wall portions 130 are continuous without a step in the first direction DR1.

In the duct 100 according to an embodiment, respective fifth wall portions 150 of the second blocks 102 adjacent in the third direction DR3 are continuous without a step in the first direction DR1, and respective sixth wall portions 160 are continuous without a step in the first direction DR1.

In the duct 100 according to an embodiment, respective seventh wall portions 170 of the third blocks 103 adjacent in the third direction DR3 are continuous without a step in the first direction DR1, and respective eighth wall portions 180 of the fourth blocks 104 adjacent in the third direction DR3 are continuous without a step in the first direction DR1.

As described above, the duct 100 according to an embodiment is formed by a plurality of sections 30, each formed by duct components 107 including one pair of the first block 101 and the second block 102, being continuous in the third direction DR3.

In the example shown in FIG. 3 and FIG. 4, it is assumed that the duct 100 according to an embodiment has, for example, four sections 30 continuous in the third direction DR3. Among the four sections 30, the section 30 located outermost on the other side in the third direction DR3 is referred to as a first section 31, and the section 30 adjacent to the first section 31 on one side in the third direction DR3 is referred to as a second section 32. Among the four sections 30, the section 30 adjacent to the second section 32 on one side in the third direction DR3 is referred to as a third section 33, and the section 30 adjacent to the third section 33 on one side in the third direction DR3 is referred to as a fourth section 34.

The number of sections 30 in the duct 100 may be two or more, and is not limited to four.

### Dimensions of Third Block 103 and Fourth Block 104 in Second Direction DR2

Regarding a distance in the second direction DR2 for a pair of the first block 101 and the second block 102 arranged at the same position in the third direction DR3, as shown in FIG. 5, a distance between an end portion 121 of the second wall portion 120 on one side in the second direction DR2 and an end portion 152 of the fifth wall portion 150 on the other side in the second direction DR2 is defined as distance A, and a distance between an end portion 131 of the third wall portion 130 on one side in the second direction DR2 and an end portion 162 of the sixth wall portion 160 on the other side in the second direction DR2 is defined as distance B.

When respective first wall portions 110 of the first blocks 101 adjacent in the third direction DR3 are continuous without a step in the second direction DR2, and respective fourth wall portions 140 of the second blocks 102 adjacent in the third direction DR3 are continuous without a step in the second direction DR2, the distance A and the distance B in a first pair of the first block 101 and the second block 102 are larger than the distance A and the distance B in a second pair of the first block 101 and the second block 102 adjacent to the first pair on one side in the third direction DR3.

In other words, in the duct 100 according to an embodiment, the dimension, in the second direction DR2, of the seventh wall portion 170 located on the other side in the third direction DR3 of two of the seventh wall portions 170 adjacent in the third direction DR3 is larger than the dimension, in the second direction DR2, of the seventh wall portion 170 located on one side in the third direction DR3 of the two of the seventh wall portions 170 adjacent in the third direction DR3.

The dimension, in the second direction DR2, of the eighth wall portion 180 located on the other side in the third direction DR3 of two of the eighth wall portions 180 adjacent in the third direction DR3 is larger than the dimension, in the second direction DR2, of the eighth wall portion 180 located on one side in the third direction DR3 of the two of the eighth wall portions 180 adjacent in the third direction DR3.

Thus, in each of the first pair and the second pair, the first block 101 and the second block 102 can be connected via the seventh wall portion 170 (the third block 103) and the eighth wall portion 180 (the fourth block 104).

That is, in the duct 100 according to an embodiment, a separation distance in the second direction DR2 of the pair of the first block 101 and the second block 102 increases toward the other side in the third direction DR3, but the first block 101 and the second block 102 can be connected via the seventh wall portion 170 (the third block 103) and the eighth wall portion 180 (the fourth block 104).

In the pair of the first block 101 and the second block 102 located outermost on one side in the third direction DR3, the first block 101 and the second block 102 are configured such that the end portion 121 of the second wall portion 120 on one side in the second direction DR2 and the end portion 152 of the fifth wall portion 150 on the other side in the second direction DR2 are directly connected without the seventh wall portion 170 interposed.

In the duct 100 according to an embodiment, the end portion 131, on one side in the second direction DR2, of the third wall portion 130 arranged outermost on one side in the third direction DR3 and the end portion 162 of the sixth wall portion 160 on the other side in the second direction DR2 are directly connected without the eighth wall portion 180 interposed.

Thus, while using the same first block 101 and second block 102 as the first block 101 and the second block 102 arranged on the other side in the third direction DR3, the dimension of the duct 100 in the second direction DR2 can be reduced in the outermost section (fourth section 34) on one side in the third direction DR3. As a result, the types of duct components 107 with different shapes can be reduced, and design effort and manufacturing cost can be reduced.

### Reinforcing Member 80

As shown in FIG. 5, in the duct 100 according to an embodiment, a reinforcing member 80 described below is preferably provided. Examples of the types of the reinforcing member 80 include the following first reinforcing member 81 to fifth reinforcing member 85.

The first reinforcing member 81 is a reinforcing member provided so as to connect the first wall portion 110 and the fourth wall portion 140.

The second reinforcing member 82 is a reinforcing member provided so as to connect the fourth wall portion 140 and the seventh wall portion 170.

The third reinforcing member 83 is a reinforcing member provided so as to connect the fourth wall portion 140 and the eighth wall portion 180.

The fourth reinforcing member 84 is a reinforcing member provided so as to connect the first wall portion 110 and the seventh wall portion 170.

The fifth reinforcing member 85 is a reinforcing member provided so as to connect the first wall portion 110 and the eighth wall portion 180.

In the duct 100 according to an embodiment, at least one of the first reinforcing member 81 to the fifth reinforcing member 85 may be provided in each of the first section 31 to the third section 33, and the first reinforcing member 81 may be provided in the fourth section 34.

This allows separate duct components 107 to be connected and reinforced, effectively increasing the strength of the duct 100.

### Assembly Procedure of Duct 100

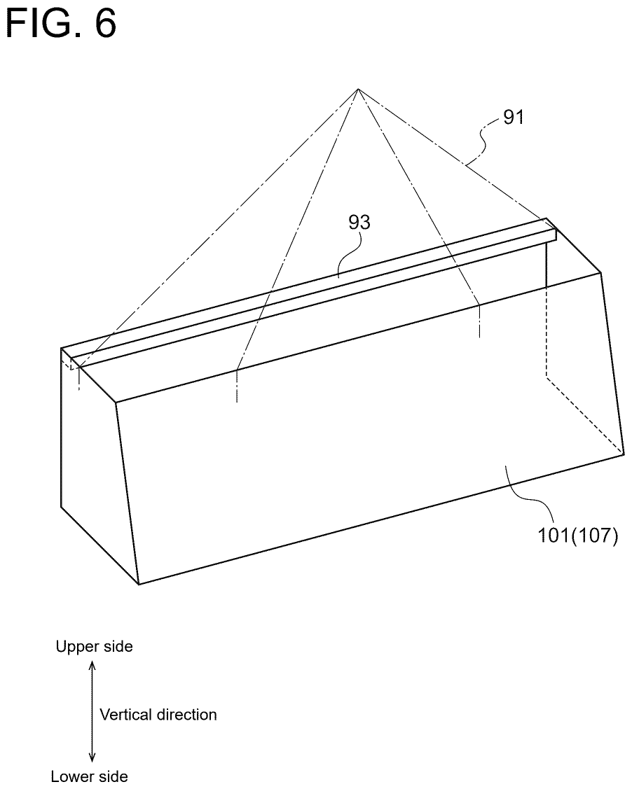

FIG. 6 is a schematic perspective view showing an example of a state during a lifting operation of duct components 107.

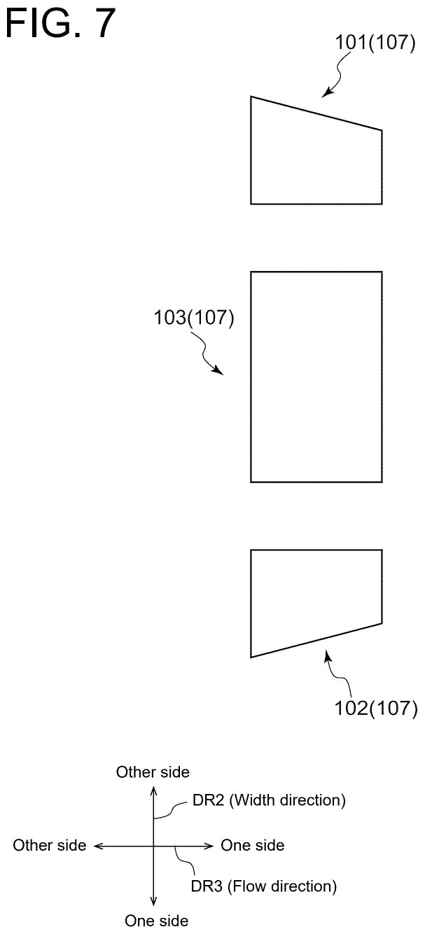

FIG. 7 is a schematic plan view for describing the assembly procedure of the duct 100.

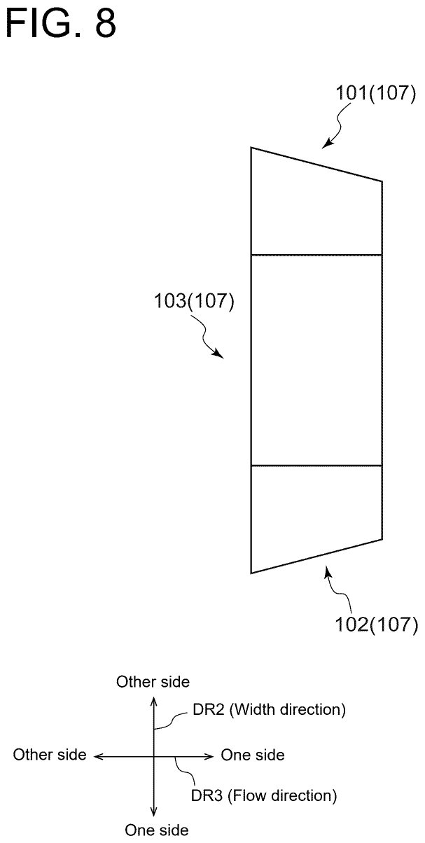

FIG. 8 is a schematic plan view for describing the assembly procedure of the duct 100.

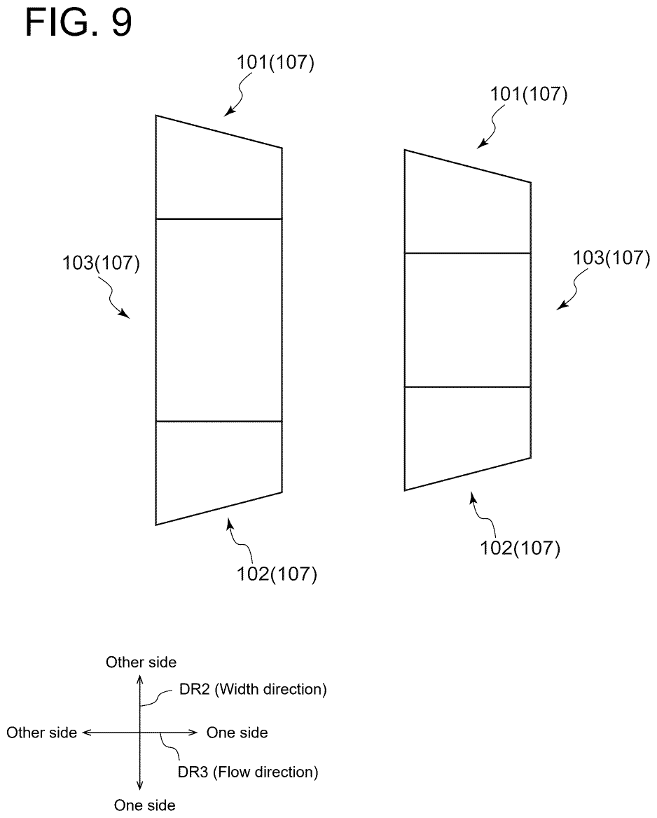

FIG. 9 is a schematic plan view for describing the assembly procedure of the duct 100

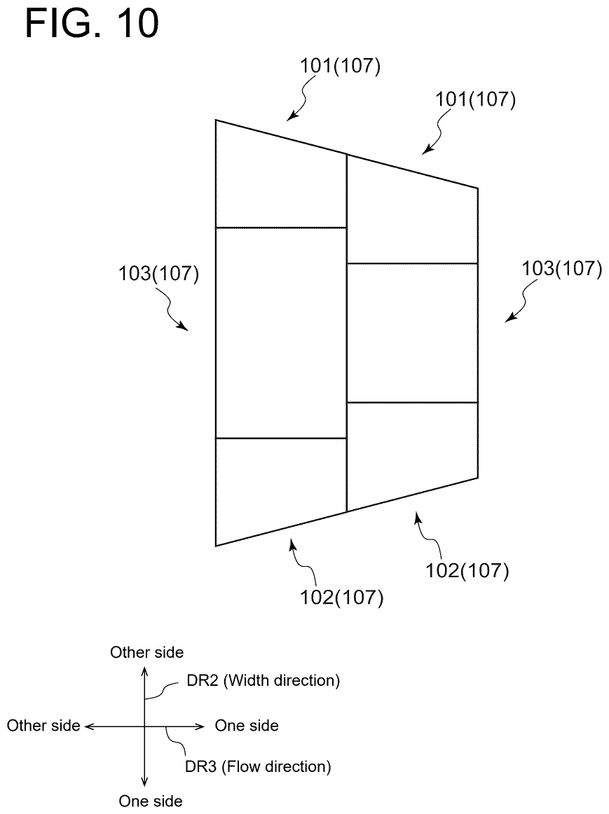

FIG. 10 is a schematic plan view for describing the assembly procedure of the duct 100.

In the duct 100 according to an embodiment, each duct component 107 may be lifted by attaching a sling wire 91 or the like as shown in FIG. 6, for example, in the process of transportation or assembly. In such a case, in order to prevent deformation of the first block 101 and the second block 102, a reinforcing member 93 is attached to each of the first block 101 and the second block 102.

The reinforcing member 93 becomes unnecessary after the assembly of the duct 100, and is therefore removed when it becomes unnecessary.

The duct 100 according to an embodiment is assembled as follows.

First, a worker prepares a plurality of duct components 107 corresponding to each section 30 as shown in FIG. 7, and connects these duct components 107 for each section 30 as shown in FIG. 8. For example, FIG. 7 and FIG. 8 show the first block 101, the second block 102, and the third block 103 among the duct components 107 corresponding to the first section 31.

The duct components 107 are connected by joining flange portions (not shown) with bolt members as described above.

Similarly, the duct components 107 are connected in each of the second section 32, the third section 33, and the fourth section 34.

In this way, the duct components 107 are connected for each section 30 of the duct 100, as shown in FIG. 9, for example. For example, FIG. 9 shows the duct components 107 of the first section 31 and the duct components 107 of the second section 32.

Next, the worker connects the duct components 107 of adjacent sections 30, as shown in FIG. 10. For example, FIG. 10 shows a state in which the duct components 107 of the first section 31 and the duct components 107 of the second section 32 are connected.

In this way, the duct 100 is assembled by connecting and integrating the first section 31 to the fourth section 34.

The present disclosure is not limited to the embodiments described above, but includes modifications to the embodiments described above, and embodiments composed of combinations of those embodiments.

The contents described in the above embodiments would be understood as follows, for instance.

(1) A duct 100 according to at least one embodiment of the present disclosure is a duct 100 that forms a passage 109 through which a fluid flows. In the duct 100 according to at least one embodiment of the present disclosure, a cross-section of the passage 109 perpendicular to a flow direction of the fluid (third direction DR3) has a rectangular shape. The duct 100 according to at least one embodiment of the present disclosure includes: a C-shaped first block 101 forming a part of the rectangular shape; and a C-shaped second block 102 forming a part of the rectangular shape and disposed opposite the first block 101 across a plane Pv including a central axis AX of the duct 100. The first block 101, when viewed along the central axis AX, includes: a first wall portion 110 extending in a first direction DR1 perpendicular to an extending direction of the central axis AX; a second wall portion 120 extending from an end portion 111 of the first wall portion 110 on one side in the first direction DR1 to one side in a second direction DR2 that is perpendicular to the extending direction of the central axis AX and intersects the first direction DR1; and a third wall portion 130 extending from an end portion 112 of the first wall portion 110 on the other side in the first direction DR1 to one side in the second direction DR2. The second block 102, when viewed along the central axis AX, includes: a fourth wall portion 140 extending in the first direction DR1; a fifth wall portion 150 extending from an end portion 141 of the fourth wall portion 140 on one side in the first direction DR1 to the other side in the second direction DR2; and a sixth wall portion 160 extending from an end portion 142 of the fourth wall portion 140 on the other side in the first direction DR1 to the other side in the second direction DR2. The duct 100 according to at least one embodiment of the present disclosure includes: a seventh wall portion 170 connecting an end portion 121 of the second wall portion 120 on one side in the second direction DR2 and an end portion 152 of the fifth wall portion 150 on the other side in the second direction DR2; and an eighth wall portion 180 connecting an end portion 131 of the third wall portion 130 on one side in the second direction DR2 and an end portion 162 of the sixth wall portion 160 on the other side in the second direction DR2. A distance between the first wall portion 110 and the fourth wall portion 140 gradually increases from one side toward the other side in the flow direction (third direction DR3). A plurality of the first blocks 101 are arranged side-by-side in the flow direction (third direction DR3), and a plurality of the second blocks 102 are arranged side-by-side in the flow direction (third direction DR3).

With the above configuration (1), by arranging a plurality of the first blocks 101 side-by-side in the flow direction (third direction DR3) and arranging a plurality of the second blocks 102 side-by-side in the flow direction (third direction DR3), a relatively large duct 100 can be installed while keeping the first blocks 101 and the second blocks 102 to a transportable size. Further, with the above configuration (1), since the duct 100 includes the plurality of first blocks 101 and second blocks 102, even for a relatively large duct 100, the types of duct components 107 with different shapes can be reduced, and design effort and manufacturing cost can be reduced.

(2) In some embodiments, in the above configuration (1), a plurality of the seventh wall portions 170 may be arranged side-by-side in the flow direction (third direction DR3), and a plurality of the eighth wall portions 180 may be arranged side-by-side in the flow direction (third direction DR3).

With the above configuration (2), by arranging a plurality of the seventh wall portions 170 side-by-side in the flow direction (third direction DR3) and arranging a plurality of the eighth wall portions 180 side-by-side in the flow direction (third direction DR3), a relatively large duct 100 can be installed while keeping the seventh wall portions 170 and the eighth wall portions 180 to a transportable size. Further, with the above configuration (2), since the duct 100 includes the plurality of seventh wall portions 170 and eighth wall portions 180, even for a relatively large duct 100, the types of duct components 107 with different shapes can be reduced, and design effort and manufacturing cost can be reduced.

(3) In some embodiments, in the above configuration (1) or (2), each of the plurality of first blocks 101 arranged side-by-side in the flow direction (third direction DR3) may have the same external dimension.

The above configuration (3) reduces the design effort, even if the duct 100 includes a plurality of the first blocks 101, because design, strength analysis during lifting, and the like need only for one first block 101. In addition, since the first blocks 101 can be manufactured in the same manufacturing process using the same components, manufacturing cost can be reduced, and since the skill level of workers involved in manufacturing tends to increase, quality improvement can also be expected.

(4) In some embodiments, in the above configuration (3), each of the plurality of second blocks 102 arranged side-by-side in the flow direction (third direction DR3) may have the same external dimension. A dimension of the second block 102 in the flow direction (third direction DR3) may be the same as a dimension of the first block 101 in the flow direction (third direction DR3).

The above configuration (4) reduces the design effort, even if the duct 100 includes a plurality of the second blocks 102, because design, strength analysis during lifting, and the like need only for one second block 102. In addition, with the above configuration (4), since the second blocks 102 can be manufactured in the same manufacturing process using the same components, manufacturing cost can be reduced, and since the skill level of workers involved in manufacturing tends to increase, quality improvement can also be expected.

With the above configuration (4), since the first block 101 and the second block 102 have the same dimension in the flow direction (third direction DR3), even if a plurality of the first blocks 101 and a plurality of the second blocks 102 are respectively arranged side-by-side in the third direction DR3, the length of the duct 100 in a region where the plurality of first blocks 101 are arranged side-by-side and the length of the duct 100 in a region where the plurality of second blocks 102 are arranged side-by-side can be matched.

(5) In some embodiments, in any of the above configurations (1) to (4), a plurality of the seventh wall portions 170 may be arranged side-by-side in the flow direction (third direction DR3), and a plurality of the eighth wall portions 180 may be arranged side-by-side in the flow direction (third direction DR3). A dimension, in the second direction DR2, of the seventh wall portion 170 located on the other side in the flow direction (third direction DR3) of two of the seventh wall portions 170 adjacent in the flow direction (third direction DR3) may be larger than a dimension, in the second direction DR2, of the seventh wall portion 170 located on one side in the flow direction (third direction DR3) of the two of the seventh wall portions 170 adjacent in the flow direction (third direction DR3). A dimension, in the second direction DR2, of the eighth wall portion 180 located on the other side in the flow direction (third direction DR3) of two of the eighth wall portions 180 adjacent in the flow direction (third direction DR3) may be larger than a dimension, in the second direction DR2, of the eighth wall portion 180 located on one side in the flow direction (third direction DR3) of the two of the eighth wall portions 180 adjacent in the flow direction (third direction DR3).

With the above configuration (5), by arranging a plurality of the seventh wall portions 170 side-by-side in the flow direction (third direction DR3) and arranging a plurality of the eighth wall portions 180 side-by-side in the flow direction (third direction DR3), a relatively large duct 100 can be installed while keeping the seventh wall portions 170 and the eighth wall portions 180 to a transportable size. Further, with the above configuration (5), since the duct 100 includes the plurality of seventh wall portions 170 and eighth wall portions 180, even for a relatively large duct 100, the types of duct components 107 with different shapes can be reduced, and design effort and manufacturing cost can be reduced.

Here, regarding a distance in the second direction DR2 for a pair of the first block 101 and the second block 102 arranged at the same position in the flow direction (third direction DR3), a distance between an end portion 121 of the second wall portion 120 on one side in the second direction DR2 and an end portion 152 of the fifth wall portion 150 on the other side in the second direction DR2 is defined as distance A, and a distance between an end portion 131 of the third wall portion 130 on one side in the second direction DR2 and an end portion 162 of the sixth wall portion 160 on the other side in the second direction DR2 is defined as distance B.

When respective first wall portions 110 of the first blocks 101 adjacent in the flow direction (third direction DR3) are continuous without a step in the second direction DR2, and respective fourth wall portions 140 of the second blocks 102 adjacent in the flow direction (third direction DR3) are continuous without a step in the second direction DR2, the distance A and the distance B in a first pair of the first block 101 and the second block 102 are larger than the distance A and the distance B in a second pair of the first block 101 and the second block 102 adjacent to the first pair on one side in the flow direction (third direction DR3).

With the above configuration (5), in each of the first pair and the second pair, the first block 101 and the second block 102 can be connected via the seventh wall portion 170 and the eighth wall portion 180.

(6) In some embodiments, in any of the above configurations (1) to (5), an external shape of the first block 101 and an external shape of the second block 102 may be symmetrical with respect to the plane Pv including the central axis AX.

With the above configuration (6), if one of the first block 101 and the second block 102 is designed, the other can be designed based on the result of that design, and if strength analysis during lifting or the like is performed for one, the result can be used for the strength analysis during lifting or the like for the other. This reduces the design burden.

(7) In some embodiments, in any of the above configurations (1) to (6), a dimension of the second block 102 in the flow direction (third direction DR3) may be the same as a dimension of the first block 101 in the flow direction (third direction DR3), and a dimension of the seventh wall portion 170 in the flow direction (third direction DR3) may be the same as the dimension of the first block 101 in the flow direction (third direction DR3).

With the above configuration (7), since the first block 101, the second block 102, and the seventh wall portion 170 have the same dimension in the flow direction (third direction DR3), even if a plurality of the first blocks 101, a plurality of the second blocks 102, and a plurality of the seventh wall portions 170 are respectively arranged side-by-side in the flow direction (third direction DR3), the length of the duct 100 in a region where the plurality of first blocks 101 are arranged side-by-side, the length of the duct 100 in a region where the plurality of second blocks 102 are arranged side-by-side, and the length of the duct 100 in a region where the plurality of seventh wall portions 170 are arranged side-by-side can be matched.

(8) In some embodiments, in any of the above configurations (1) to (7), in a partial section on one side in the flow direction (third direction DR3), the first block 101 and the second block 102 may be configured such that: the end portion 121 of the second wall portion 120 on one side in the second direction DR2 and the end portion 152 of the fifth wall portion 150 on the other side in the second direction DR2 are directly connected without the seventh wall portion 170 interposed; and the end portion 131 of the third wall portion 130 on one side in the second direction DR2 and the end portion 162 of the sixth wall portion 160 on the other side in the second direction DR2 are directly connected without the eighth wall portion 180 interposed.

With the above configuration (8), while using the same first block 101 and second block 102 as the first block 101 and the second block 102 arranged on the other side in the flow direction (third direction DR3), the dimension of the duct 100 in the second direction DR2 can be reduced in a section (fourth section 34) on one side in the flow direction (third direction DR3). As a result, the types of duct components 107 with different shapes can be reduced, and design effort and manufacturing cost can be reduced.

(9) In some embodiments, in any of the above configurations (1) to (8), a distance between a first wall portion group (side wall portion 21) formed by respective first wall portions 110 of the plurality of first blocks 101 arranged side-by-side in the flow direction (third direction DR3) and a fourth wall portion group (side wall portion 22) formed by respective fourth wall portions 140 of the plurality of second blocks 102 arranged side-by-side in the flow direction (third direction DR3) may gradually increase from one side toward the other side in the flow direction (third direction DR3).

The above configuration (9) results in a duct 100 with a flow path area that gradually increases from one side to the other side in the third direction DR3.

(10) In some embodiments, in any of the above configurations (1) to (9), the duct may include at least one of: a first reinforcing member 81 connecting the first wall portion 110 and the fourth wall portion 140; a second reinforcing member 82 connecting the fourth wall portion 140 and the seventh wall portion 170; a third reinforcing member 83 connecting the fourth wall portion 140 and the eighth wall portion 180; a fourth reinforcing member 84 connecting the first wall portion 110 and the seventh wall portion 170; or a fifth reinforcing member 85 connecting the first wall portion 110 and the eighth wall portion 180.

The above configuration (10) allows separate duct components 107 to be connected and reinforced, effectively increasing the strength of the duct 100.

(11) A gas turbine 1 according to at least one embodiment of the present disclosure includes: a compressor 2 for generating compressed air; a combustor 3 for generating combustion gas by burning a mixture of the compressed air generated by the compressor 2 and fuel; a turbine 4 driven to rotate by the combustion gas generated by the combustor 3; an intake duct 6 of the compressor 2; and an exhaust duct 13 of the turbine 4. At least one of the intake duct 6 or the exhaust duct 13 has a cross-sectional shape of the passage 109 changed by the duct 100 having any one of the above configurations (1) to (10).

With the above configuration (11), a relatively large duct 100 can be installed while keeping the size of the duct components 107 to a transportable size. Further, with the above configuration (11), even for a relatively large duct 100, the types of duct components 107 with different shapes can be reduced, and design effort and manufacturing cost can be reduced.

1. A duct that forms a passage through which a fluid flows,
a cross-section of the passage perpendicular to a flow direction of the fluid having a rectangular shape,
wherein the duct comprises:
a C-shaped first block forming a part of the rectangular shape; and
a C-shaped second block forming a part of the rectangular shape and disposed opposite the first block across a plane including a central axis of the duct,
wherein the first block, when viewed along the central axis, includes:
a first wall portion extending in a first direction perpendicular to an extending direction of the central axis;
a second wall portion extending from an end portion of the first wall portion on one side in the first direction to one side in a second direction that is perpendicular to the extending direction of the central axis and intersects the first direction; and
a third wall portion extending from an end portion of the first wall portion on the other side in the first direction to the one side in the second direction,
wherein the second block, when viewed along the central axis, includes:
a fourth wall portion extending in the first direction;
a fifth wall portion extending from an end portion of the fourth wall portion on the one side in the first direction to the other side in the second direction; and
a sixth wall portion extending from an end portion of the fourth wall portion on the other side in the first direction to the other side in the second direction,
wherein the duct comprises:
a seventh wall portion connecting an end portion of the second wall portion on the one side in the second direction and an end portion of the fifth wall portion on the other side in the second direction; and
an eighth wall portion connecting an end portion of the third wall portion on the one side in the second direction and an end portion of the sixth wall portion on the other side in the second direction,
wherein a distance between the first wall portion and the fourth wall portion gradually increases from one side toward the other side in the flow direction,
wherein a plurality of the first blocks are arranged side-by-side in the flow direction, and
wherein a plurality of the second blocks are arranged side-by-side in the flow direction.

2. The duct according to claim 1,
wherein a plurality of the seventh wall portions are arranged side-by-side in the flow direction, and
wherein a plurality of the eighth wall portions are arranged side-by-side in the flow direction.

3. The duct according to claim 1,
wherein each of the plurality of first blocks arranged side-by-side in the flow direction has the same external dimension.

4. The duct according to claim 3,
wherein each of the plurality of second blocks arranged side-by-side in the flow direction has the same external dimension, and
wherein a dimension of the second block in the flow direction is the same as a dimension of the first block in the flow direction.

5. The duct according to claim 1,
wherein a plurality of the seventh wall portions are arranged side-by-side in the flow direction,
wherein a plurality of the eighth wall portions are arranged side-by-side in the flow direction,
wherein a dimension, in the second direction, of the seventh wall portion located on the other side in the flow direction of two of the seventh wall portions adjacent in the flow direction is larger than a dimension, in the second direction, of the seventh wall portion located on the one side in the flow direction of the two of the seventh wall portions adjacent in the flow direction, and
wherein a dimension, in the second direction, of the eighth wall portion located on the other side in the flow direction of two of the eighth wall portions adjacent in the flow direction is larger than a dimension, in the second direction, of the eighth wall portion located on the one side in the flow direction of the two of the eighth wall portions adjacent in the flow direction.

6. The duct according to claim 1,
wherein an external shape of the first block and an external shape of the second block are symmetrical with respect to the plane including the central axis.

7. The duct according to claim 1,
wherein a dimension of the second block in the flow direction is the same as a dimension of the first block in the flow direction, and
wherein a dimension of the seventh wall portion in the flow direction is the same as the dimension of the first block in the flow direction.

8. The duct according to claim 1,
wherein in a partial section on the one side in the flow direction, the first block and the second block are configured such that:
the end portion of the second wall portion on the one side in the second direction and the end portion of the fifth wall portion on the other side in the second direction are directly connected without the seventh wall portion interposed; and
the end portion of the third wall portion on the one side in the second direction and the end portion of the sixth wall portion on the other side in the second direction are directly connected without the eighth wall portion interposed.

9. The duct according to claim 1,
wherein a distance between a first wall portion group formed by respective first wall portions of the plurality of first blocks arranged side-by-side in the flow direction and a fourth wall portion group formed by respective fourth wall portions of the plurality of second blocks arranged side-by-side in the flow direction gradually increases from the one side toward the other side in the flow direction.

10. The duct according to claim 1, comprising at least one of:
a first reinforcing member connecting the first wall portion and the fourth wall portion;
a second reinforcing member connecting the fourth wall portion and the seventh wall portion;
a third reinforcing member connecting the fourth wall portion and the eighth wall portion;
a fourth reinforcing member connecting the first wall portion and the seventh wall portion; or
a fifth reinforcing member connecting the first wall portion and the eighth wall portion.

11. A gas turbine, comprising:
a compressor for generating compressed air;
a combustor for generating combustion gas by burning a mixture of the compressed air generated by the compressor and fuel;
a turbine driven to rotate by the combustion gas generated by the combustor;
an intake duct of the compressor; and
an exhaust duct of the turbine,
wherein at least one of the intake duct or the exhaust duct has a cross-sectional shape of the passage changed by the duct according to claim 1.
